(19) United States
(12) Patent Application Publication
(10) Pub. No.: US 2025/0072488 A1
(43) Pub. Date: Mar. 6, 2025

(54) PACKAGING MATERIAL FOR NICOTINE POUCH, NICOTINE POUCH INCLUDING THE SAME, AND METHOD OF PREPARING THE SAME

(71) Applicant: KT&G CORPORATION, Daejeon (KR)

(72) Inventors: Sung Je CHA, Daejeon (KR); Sung Jong KI, Daejeon (KR); Eun Mi JEOUNG, Daejeon (KR); Jun Won SHIN, Daejeon (KR)

(73) Assignee: KT&G CORPORATION, Daejeon (KR)

(21) Appl. No.: 18/818,968

(22) Filed: Aug. 29, 2024

(30) Foreign Application Priority Data
Aug. 31, 2023 (KR) 10-2023-0115684

(51) Int. Cl. A24F 23/02; D04H 1/425

(52) U.S. Cl. CPC A24F 23/02; D04H 1/425

(57) ABSTRACT

Provided is a packaging material for a nicotine pouch, the packaging material including a cellulose fiber, and a thermoplastic material fiber, wherein a content of the cellulose fiber is 40 to 80 wt % with respect to a total weight of the packaging material for the nicotine pouch, and a content of the thermoplastic material fiber is 20 to 60 wt % with respect to the total weight of the packaging material for the nicotine pouch.

### CROSS-REFERENCE TO RELATED APPLICATION

This application claims the benefit of Korean Patent Application No. 10-2023-0115684 filed on Aug. 31, 2023, in the Korean Intellectual Property Office, the entire disclosure of which is incorporated herein by reference for all purposes.

### BACKGROUND

### 1. Field of the Invention

One or more embodiments relate to a packaging material for a nicotine pouch, a nicotine pouch including the same, and a method of preparing the same.

### 2. Description of the Related Art

Nicotine pouches are one type of smoking article and are used in the mouth of a user to provide nicotine satisfaction to the user. For example, nicotine pouches may be used by a user placing the pouch between the upper or lower gums and lips and holding it there for a limited period of time.

A nicotine pouch includes a filler packaged in a packaging material. The packaging material for the nicotine pouch holds a nicotine pouch filler in place and allows saliva to pass through the filler, and a flavor and nicotine released from the nicotine pouch filler diffuse into the user's mouth.

At this time, the packaging material for the nicotine pouch must not burst during the manufacturing and distribution process, and must provide a positive tactile sensation to smokers during use in the mouth while preventing the nicotine pouch filler from coming out.

Meanwhile, to prepare the packaging material for the nicotine pouch, a spun-lacing method is mainly used among non-woven fabric manufacturing methods. The spun-lacing method may include forming a web in a form of a sheet with a predetermined thickness with crumpled fiber raw material, forming a material of a packaging material by spraying moisture such that fibers are tangled, and drying. However, a packaging for a nicotine pouch manufactured using the spun-lacing method has a problem regarding a non-uniform airtightness.

### SUMMARY

Embodiments provide a packaging material for a nicotine pouch having uniform airtightness and a strength that prevents the nicotine pouch from bursting, and capable of providing a soft feel.

However, goals to be achieved are not limited to those described above, and other goals not mentioned above are clearly understood by one of ordinary skill in the art from the following description.

According to an aspect, there is provided a packaging material for a nicotine pouch, the packaging material including a cellulose fiber, and a thermoplastic material fiber, wherein a content of the cellulose fiber is 40 to 80 wt % with respect to a total weight of the packaging material for the nicotine pouch, and a content of the thermoplastic material fiber is 20 to 60 wt % with respect to the total weight of the packaging material for the nicotine pouch.

According to another aspect, there is provided a nicotine pouch including a nicotine pouch filler, and a packaging material for the nicotine pouch, wherein the packaging material for the nicotine pouch includes a cellulose fiber, and a thermoplastic material fiber, a content of the cellulose fiber is 40 to 80 wt % with respect to a total weight of the packaging material for the nicotine pouch, and a content of the thermoplastic material fiber is 20 to 60 wt % with respect to the total weight of the packaging material for the nicotine pouch.

According to still another aspect, there is provided a method of preparing a nicotine pouch, the method including step S1 of preparing a dispersion of a cellulose fiber and a thermoplastic material fiber, step S2 of forming a packaging material for the nicotine pouch by moving the dispersion to a paper machine, and step S3 of performing dehydrating and drying, wherein the packaging material for the nicotine pouch includes a cellulose fiber, and a thermoplastic material fiber, a content of the cellulose fiber is 40 to 80 wt % with respect to a total weight of the packaging material for the nicotine pouch, and a content of the thermoplastic material fiber is 20 to 60 wt % with respect to the total weight of the packaging material for the nicotine pouch.

According to still another aspect, there is provided a method of preparing a nicotine pouch, the method including step R1 of preparing a packaging material for a nicotine pouch according to a method of preparing a packaging material of a nicotine pouch according to an aspect, and step R2 of sealing the packaging material for the nicotine pouch.

Additional aspects of embodiments will be set forth in part in the description which follows and, in part, will be apparent from the description, or may be learned by practice of the disclosure.

According to the disclosure, it is possible to provide a nicotine pouch having uniform airtightness, excellent tensile strength and sealing strength, and excellent feeling of use by providing a soft feel to smokers.

It should be understood that the effects of the present disclosure are not limited to the above-described effects, but are construed as including all effects that may be inferred from the configurations and features described in the following description or claims of the present disclosure.

### DETAILED DESCRIPTION

Hereinafter, embodiments will be described in detail. However, various alterations and modifications may be made to the embodiments and thus, the scope of the disclosure is not limited or restricted to the embodiments. The equivalents should be understood to include all changes, equivalents, and replacements within the idea and the technical scope of the disclosure.

The terminology used herein is for the purpose of describing particular embodiments only and is not to be limiting of the embodiments. The singular forms “a,” “an,” and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which the embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

In the description of embodiments, detailed description of well-known related structures or functions will be omitted when it is deemed that such description will cause ambiguous interpretation of the present disclosure.

In addition, the terms first, second, A, B, (a), and (b) may be used to describe constituent elements of the embodiments. These terms are used only for the purpose of discriminating one component from another component, and the nature, the sequences, or the orders of the components are not limited by the terms.

A component, which has the same common function as a component included in any one embodiment, will be described by using the same name in other embodiments. Unless disclosed to the contrary, the description of any one embodiment may be applied to other embodiments, and the specific description of the repeated configuration will be omitted.

It will be understood that when a certain part “includes” a certain component, the part does not exclude another component but may further include another component.

According to an embodiment, there is provided a packaging material for a nicotine pouch, the packaging material including a cellulose fiber, and a thermoplastic material fiber, wherein a content of the cellulose fiber is 40 to 80 wt % with respect to a total weight of the packaging material for the nicotine pouch, and a content of the thermoplastic material fiber is 20 to 60 wt % with respect to the total weight of the packaging material for the nicotine pouch.

The packaging material for the nicotine pouch may be safe for the human body, hold saliva well, have a certain strength to prevent tearing, and have sealing properties.

A material of the packaging material for the nicotine pouch may be a nonwoven or woven type material, desirably a nonwoven type material. Unlike the woven type material, the non-woven type material has tangled fibers, and thus, there may be no vertical or horizontal direction, and cut edges may not unravel.

Desirably, in the packaging material for the nicotine pouch according to an embodiment, the content of the cellulose fiber may be 55 to 65 wt % with respect to the total weight of the packaging material for the nicotine pouch, and the content of the thermoplastic material fiber may be 35 to 45 wt % with respect to the total weight of the packaging material for the nicotine pouch.

In the packaging material for the nicotine pouch according to an embodiment, a weight ratio of the cellulose fiber to the thermoplastic material fiber may be 4:6 to 8:2, desirably 6:4 to 8:2, and more desirably 6:4.

The cellulose fiber may increase the airtightness and physical strength of the packaging material for the nicotine pouch and seal the nicotine pouch by adding the thermoplastic material fiber. However, when the content of the cellulose fiber is less than the numerical range described above and the content of the thermoplastic material fiber is more than the numerical range described above, the packaging material for the nicotine pouch may be easily torn due to a low tensile strength. On the other hand, when the content of the cellulose fiber is more than the numerical range described above and the content of the thermoplastic material fiber is less than the numerical range described above, the pouch may easily burst and a filler filled inside may easily come out due to a low sealing strength of the packaging material for the nicotine pouch.

The cellulose fiber may not only increase the tensile strength of the packaging material for the nicotine pouch, but also improve the feeling of use (softness).

For example, the cellulose fibers may include not only cellulose but also a cellulose-based fiber. The cellulose-based fiber may include at least one or more of a natural cellulose-based fiber or an artificial cellulose-based fiber.

The natural cellulose-based fiber may include at least one or more selected from a group consisting of a seed hair fiber, a bast fiber, a leaf fiber, and a wood fiber (pulp). The seed hair fiber may include, for example, cotton, bombax cotton, kapok, and the like. The bast fiber may include, for example, hemp, flax, jute, ramie grass, mulberry tree, and edgeworthia chrysantha, and the like. The leaf fiber may include, for example, Manila hemp, New Zealand hemp, and the like. The wood fiber (pulp) may include at least one or more of softwood pulp or hardwood pulp, depending on the type and characteristics of the tree, and examples thereof may include a softwood fiber, a hardwood fiber, and the like.

The artificial cellulose-based fiber may include at least one or more of a regenerated cellulose fiber or a semi-synthetic fiber. The regenerated cellulose fiber may include, for example, viscose, rayon, forty acid, and the like. The semi-synthetic fiber may, for example, include an acetate fiber.

The rayon may include not only rayon but also a rayon-based fiber that compensates for the shortcomings of rayon. The rayon-based fiber may include, for example, Tencel, lyocell, modal, and the like.

Desirably, in the packaging material for the nicotine pouch according to an embodiment, the cellulose fiber may include at least one or more selected from a group consisting of cellulose, viscose, rayon, and pulp.

In the packaging material for the nicotine pouch according to an embodiment, when the cellulose fiber is pulp, the pulp may be beaten. The “beating” herein may refer to putting a fiber into water and cutting it to make them finer through a mechanical action. Pulp may be in a state of being easier to hydrogen bond as a length and a structure of the fiber change through the beating, thereby giving a physical strength to a pouch material.

By including the thermoplastic material fiber, the packaging material for the nicotine pouch may be sealed with heat.

In the packaging material for the nicotine pouch according to an embodiment, the thermoplastic material fiber may include at least one or more selected from a group consisting of nylon, polylactic acid, polyethylene, polypropylene, polyethylene/polypropylene, polyethersulfone, polyethylene terephthalate, and low-melting-point polyethylene terephthalate (LMPET).

In addition, in the packaging material for the nicotine pouch according to an embodiment, the thermoplastic material fiber may be a dual component fiber including two selected from a group consisting of polypropylene, polyethylene, polyethylene terephthalate, and polylactic acid, and the thermoplastic material fiber may form a core-shell structure. A fiber with such a core-shell structure may have the advantage of excellent physical properties and excellent sealing properties at low temperatures.

The thermoplastic material fiber may include a staple fiber. The staple fiber is a fiber with a discontinuous length and may be cut from a continuous filament.

In the packaging material for the nicotine pouch according to an embodiment, the packaging material for the nicotine pouch may have a basis weight of 10 g/m² to 50 g/m², and desirably 30 g/m².

When the basis weight of the packaging material for the nicotine pouch is less than the numerical range described above, the strength of the material for the nicotine pouch may be reduced. On the other hand, when the basis weight of the packaging material for the nicotine pouch exceeds the numerical range described above, moisture movement may become difficult when using the nicotine pouch, which may inhibit the release of active components (nicotine, a flavor, etc.) of the filler.

In the packaging material for the nicotine pouch according to an embodiment, the packaging material for the nicotine pouch may have a thickness of 50 μm to 150 μm, and desirably 100 μm.

When the thickness of the packaging material for the nicotine pouch is less than the numerical range described above, the nicotine pouch may easily burst. On the other hand, when the thickness of the packaging material for the nicotine pouch exceeds the numerical range described above, the moisture movement may become difficult when using the nicotine pouch, which may inhibit the release of active components (nicotine, a flavor, etc.) of the filler.

In the packaging material for the nicotine pouch according to an embodiment, the packaging material for the nicotine pouch may have airtightness of 5 mg to 100 mg, and desirably 10 mg to 60 mg. In particular, when the airtightness of the packaging material for the nicotine pouch exceeds the numerical range described above, the filler may leak.

In the packaging material for the nicotine pouch according to an embodiment, the packaging material for the nicotine pouch may have a tensile strength of 0.1 N/mm² to 5 N/mm², and desirably 1 N/mm² to 1.4 N/mm². When the tensile strength of the packaging material for the nicotine pouch is less than the numerical range described above, the nicotine pouch may burst during manufacturing or during oral use.

In the packaging material for the nicotine pouch according to an embodiment, the packaging material for the nicotine pouch may have a sealing strength of 0.02 N/mm² to 0.3 N/mm², and desirably 0.04 N/mm² to 0.25 N/mm², and it is desirable that the packaging material for the nicotine pouch has a high sealing strength. On the other hand, when the sealing strength of the packaging material for the nicotine pouch is less than the numerical range described above, packaging material for the nicotine pouch may easily burst and the nicotine pouch may easily burst, which easily causes a filler filled inside to easily come out.

According to an embodiment, there is provided a nicotine pouch including a nicotine pouch filler; and a packaging material for the nicotine pouch. The packaging material for the nicotine pouch may include a cellulose fiber, and a thermoplastic material fiber, a content of the cellulose fiber may be 40 to 80 wt % with respect to a total weight of the packaging material for the nicotine pouch, and a content of the thermoplastic material fiber may be 20 to 60 wt % with respect to the total weight of the packaging material for the nicotine pouch.

In the nicotine pouch according to an embodiment, the nicotine pouch filler may include nicotine, a release control excipient including at least one or more selected from a group consisting of cellulose and sugar alcohol, a binder, a pH adjuster, and a flavoring agent.

In the nicotine pouch filler, the nicotine may include nicotine salt, and the type of nicotine salt may include at least one or more selected from a group consisting of nicotine salt benzoate, nicotine salt tartrate, nicotine salt malate, and nicotine salt salicylate.

The content of the nicotine may be determined according to a desired strength of the nicotine pouch. When the content of the nicotine is less than the range described above, it is difficult to give the smoker the satisfaction of smoking. On the other hand, when the content of the nicotine exceeds the range described above, nicotine stimulation may be excessive.

In the nicotine pouch filler, the release control excipient may adjust a nicotine elution rate.

In the nicotine pouch filler, the binder may include at least one or more selected from a group consisting of Povidone K-25, hydroxypropyl cellulose (HPC), low-substituted hydroxypropyl cellulose (L-HPC), hydroxypropylmethyl cellulose (HPMC), and carboxymethylcellulose (CMC).

The binder may be added by a wet binder adding method or a dry binder adding method.

The pH adjuster may adjust the pH of the nicotine pouch filler to a pH with which nicotine may be absorbed such that nicotine may be converted to a free-based nicotine form that may be absorbed quickly when the nicotine pouch is inserted into the mouth. A pH of the nicotine pouch filler may be 8.3 to 8.5. The pH adjuster may be at least one or more selected from a group consisting of sodium bicarbonate and sodium carbonate.

The flavoring agent may provide a taste to satisfy the smoker's preference and is not limited to a specific flavoring agent.

The packaging material for the nicotine pouch may package a predetermined amount of the filler. The packaging material for the nicotine pouch may be packaged so that the nicotine pouch filler inside does not leak out during transportation and use after being packaged, and may be prepared so that smokers do not feel a foreign body sensation in their mouth when using it.

According to an embodiment, there is provided a method of preparing a nicotine pouch, the method including step S1 of preparing a dispersion of a cellulose fiber and a thermoplastic material fiber, step S2 of forming a packaging material for the nicotine pouch by moving the dispersion to a paper machine, and step S3 of performing dehydrating and drying, wherein the packaging material for the nicotine pouch includes a cellulose fiber, and a thermoplastic material fiber, a content of the cellulose fiber is 40 to 80 wt % with respect to a total weight of the packaging material for the nicotine pouch, and a content of the thermoplastic material fiber is 20 to 60 wt % with respect to the total weight of the packaging material for the nicotine pouch.

In the method of preparing the nicotine pouch according to an embodiment, a method of preparing the packaging material for the nicotine pouch may be a wet preparation method. When the wet preparation method is used, it is possible to prepare a packaging material for a nicotine pouch with uniform airtightness.

Hereinafter, each step will be described in detail.

Step S1 may be step of preparing a dispersion of a cellulose fiber and a thermoplastic material fiber. In this step, the cellulose fiber and the thermoplastic material fiber may be evenly dispersed in a solvent. At this time, the solvent may be water.

In the method of preparing the packaging material for the nicotine pouch according to an embodiment, step S1 may include selectively beating the cellulose fiber. That is, step S1 may include beating the cellulose fiber, and preparing a dispersion by mixing the beaten cellulose fiber and the thermoplastic material fiber. For example, the cellulose fiber may be pulp. The pulp may give a physical strength to a pouch material through this step.

Step S2 is a step of forming a packaging material for a nicotine pouch by moving the prepared dispersion to the paper machine. In step S2, the paper machine may be a machine that supplies a dispersion uniformly and produces a continuous web quickly and in large quantities.

Step S3 is a step of performing dehydrating and drying. In step S3, the supplied dispersion may be dehydrated and dried, and through this, a thin packaging material for a nicotine pouch may be finally formed.

The method of preparing the nicotine pouch according to an embodiment may further include sealing the packaging material for the nicotine pouch filled with a nicotine pouch filler after step S3. In this step, a thermal or ultrasonic fusion method may be used, and at this time, the packaging material for the nicotine pouch may be sealed by adjusting conditions such as a temperature according to the type of thermoplastic material fiber and/or the manufacturing conditions of the packaging material.

Hereinafter, the present disclosure will be described in more detail with reference to examples, however, the present disclosure is not limited to the examples below.

### 1. Preparation of Packaging Material for Nicotine Pouch

### Preparation Example 1

A packaging material for a nicotine pouch including a cellulose fiber and a thermoplastic material fiber in a weight ratio of 6:4 was prepared. At this time, soft pulp made from coniferous trees was used as the cellulose fiber, and a core-shell type polypropylene/polyethylene fiber was used as the thermoplastic material fiber. The preparation method is as follows.

First, the soft pulp was beaten and then mixed with a core-shell type polypropylene/polyethylene fiber and water to prepare a dispersion. The dispersion was moved to a paper machine, dehydrated and dried to finally obtain a packaging material for a nicotine pouch.

### Preparation Example 2

A packaging material for a nicotine pouch was prepared in the same manner as in Preparation Example 1, except that the cellulose fiber and the thermoplastic material fiber are included in a weight ratio of 4:6.

### Preparation Example 3

A packaging material for a nicotine pouch was prepared in the same manner as in Preparation Example 1, except that the cellulose fiber and the thermoplastic material fiber are included in a weight ratio of 8:2.

### Comparative Example 1

A packaging material for a nicotine pouch was prepared in the same manner as in Preparation Example 1, except that a spun-lacing preparation method was used.

### 2. Experimental Example 1: Evaluation of Airtightness of Packaging Material for Nicotine Pouch

Airtightness of Preparation Examples 1 to 3 and Comparative Example 1 was evaluated. The airtightness was measured as follows. First, the prepared packaging material for the nicotine pouch was placed between circular sieves with a diameter of 21 cm. At this time, an upper circular sieve was 10 mesh (a size of opening: 2 mm), and a lower circular sieve was 12 mesh (a size of opening: 1.7 mm). After that, 40 g of a granular filler (an average particle size: 250 μm) was placed on the upper circular sieve, and shaken, and a weight of the filler remaining on the lower sieve was measured and evaluated. The results thereof are shown in Table 1 below.

TABLE 1

| Classification | Airtightness |
|---|---|
| Preparation Example 1 | Good (22 mg) |
| Preparation Example 2 | Good (57 mg) |
| Preparation Example 3 | Good (11 mg) |
| Comparative Example 1 | Poor (850 mg) |

It was confirmed that Preparation Examples 1 to 3, unlike Comparative Example 1, had good airtightness with 11 mg to 57 mg of filler remaining on the lower sieve.

From the results of Preparation Examples 1 to 3, it was confirmed that an increase in the content of the cellulose and a decrease in the content of the thermoplastic material fiber cause higher airtightness.

### 3. Experimental Example 2: Evaluation of Soft Characteristics of Packaging Material for Nicotine Pouch

A sensory evaluation was conducted to evaluate the soft characteristics of Preparation Examples 1 to 3 and Comparative Example 1. The sensory evaluation was conducted by preparing pouches having a size of 28 mm×15 mm of Preparation Examples and Comparative Example, and five panel members used the pouches in the mouth and evaluated the pouches out of 5 pointes. The results thereof are shown in Table 2.

TABLE 2

| Classification | Soft characteristics |
|---|---|
| Preparation Example 1 | 4.4 |
| Preparation Example 2 | 3.1 |
| Preparation Example 3 | 4.7 |
| Comparative Example 1 | 4.5 |

From Table 2, it may be found that Preparation Examples 1 and 3 exhibit particularly soft characteristics compared to Preparation Example 2.

### 4. Experimental Example 3: Evaluation of Tensile Strength and Sealing Strength of Packaging Material for Nicotine Pouch

A tensile strength and a sealing strength of Preparation Examples 1 to 3 and Comparative Example 1 were evaluated. The tensile strength was evaluated by cutting Preparation Examples and Comparative Example into a size of 15 mm in width and 20 mm in length or more and applying a measurement method of EDANA NWEP 110.1.R10. The sealing strength was evaluated by cutting two sheets of Preparation Examples and Comparative Example into a size of 15 mm in width and 20 mm in length or more, sealing transverse ends using a manual heat sealer (width of 2 mm, 150° C., 2 seconds), and then applying a measurement method of the tensile strength. The results are shown in Table 3.

TABLE 3

| | Tensile | Sealing |
|---|---|---|
| Classification | strength (N/mm²) | strength (N/mm²) |
| Preparation Example 1 | 1.3 | 0.25 |
| Preparation Example 2 | 0.4 | Not measurable |
| Preparation Example 3 | 4.0 | 0.04 |
| Comparative Example 1 | 1.5 | 0.23 |

In Preparation Example 2, the sealing strength was higher than the tensile strength, and thus, the sealing strength was not able to be measured.

From the results of Preparation Examples 1 to 3, it was found that, as the content of cellulose fiber increased and the content of thermoplastic material fiber decreased, the tensile strength tended to increase, but the sealing strength tended to decrease. Preparation Example 1 showed excellent results in both tensile strength and sealing strength.

From the experimental example above, it is predicted that by using the packaging material for the nicotine pouch described in the claims, it is possible to prepare a nicotine pouch that is airtight and soft, and has excellent tensile strength.

While the embodiments are described, it will be apparent to one of ordinary skill in the art that various alterations and modifications in form and details may be made in these embodiments without departing from the spirit and scope of the claims and their equivalents. For example, suitable results may be achieved if the described techniques are performed in a different order, and/or if components in a described system, architecture, device, or circuit are combined in a different manner, and/or replaced or supplemented by other components or their equivalents.

Therefore, other implementations, other embodiments, and equivalents to the claims are also within the scope of the following claims.

What is claimed is:

1. A packaging material for a nicotine pouch, the packaging material comprising:
a cellulose fiber; and
a thermoplastic material fiber,
wherein a content of the cellulose fiber is 40 to 80 wt % with respect to a total weight of the packaging material for the nicotine pouch, and
wherein a content of the thermoplastic material fiber is 20 to 60 wt % with respect to the total weight of the packaging material for the nicotine pouch.

2. The packaging material of claim 1, wherein
the content of the cellulose fiber is 55 to 65 wt % with respect to the total weight of the packaging material for the nicotine pouch, and
the content of the thermoplastic material fiber is 35 to 45 wt % with respect to the total weight of the packaging material for the nicotine pouch.

3. The packaging material of claim 1, wherein a weight ratio of the cellulose fiber to the thermoplastic material fiber is 4:6 to 8:2.

4. The packaging material of claim 1, wherein the cellulose fiber comprises at least one or more selected from a group consisting of cellulose, viscose, rayon, and pulp.

5. The packaging material of claim 1, wherein
the cellulose fiber is pulp, and
the pulp is beaten.

6. The packaging material of claim 1, wherein the thermoplastic material fiber comprises at least one or more selected from a group consisting of nylon, polylactic acid, polyethylene, polypropylene, polyethylene/polypropylene, polyethersulfone, polyethylene terephthalate, and low-melting-point polyethylene terephthalate.

7. The packaging material of claim 1, wherein the thermoplastic material fiber is a dual component fiber comprising two selected from a group consisting of polypropylene, polyethylene, polyethylene terephthalate, and polylactic acid, and
the thermoplastic material fiber forms a core-shell structure.

8. The packaging material of claim 1, wherein
the packaging material for the nicotine pouch has a basis weight of 10 g/m², and
the packaging material for the nicotine pouch has a thickness of 50 μm to 150 μm.

9. The packaging material of claim 1, wherein
the packaging material for the nicotine pouch has airtightness of 5 mg to 100 mg,
the packaging material for the nicotine pouch has a tensile strength of 0.1 N/mm² to 5 N/mm², and
the packaging material for the nicotine pouch has a seal strength of 0.02 N/mm² to 0.3 N/mm².

10. A nicotine pouch comprising:
a nicotine pouch filler; and
a packaging material for the nicotine pouch,
wherein the packaging material for the nicotine pouch comprises:
a cellulose fiber; and
a thermoplastic material fiber,
wherein a content of the cellulose fiber is 40 to 80 wt % with respect to a total weight of the packaging material for the nicotine pouch, and
wherein a content of the thermoplastic material fiber is 20 to 60 wt % with respect to the total weight of the packaging material for the nicotine pouch.

11. The nicotine pouch of claim 10, wherein the nicotine pouch filler comprises:
nicotine;
a release control excipient comprising at least one or more selected from a group consisting of cellulose and sugar alcohol;
a binder;
a pH adjuster; and
a flavoring agent.

12. A method of preparing a nicotine pouch, the method comprising:
step S1 of preparing a dispersion of a cellulose fiber and a thermoplastic material fiber;
step S2 of forming a packaging material for the nicotine pouch by moving the dispersion to a paper machine; and
step S3 of performing dehydrating and drying,
wherein the packaging material for the nicotine pouch comprises:
a cellulose fiber; and
a thermoplastic material fiber,
wherein a content of the cellulose fiber is 40 to 80 wt % with respect to a total weight of the packaging material for the nicotine pouch, and
wherein a content of the thermoplastic material fiber is 20 to 60 wt % with respect to the total weight of the packaging material for the nicotine pouch.

13. The method of claim 12, wherein step S1 comprises beating the cellulose fiber.

14. The method of claim 12, further comprising:
sealing the packaging material for the nicotine pouch filled with the nicotine pouch filler after step S3.
